(19) United States
(12) Patent Application Publication
(10) Pub. No.: US 2016/0308904 A1
(43) Pub. Date: Oct. 20, 2016

(54) INTEGRATIVE NETWORK MANAGEMENT METHOD AND APPARATUS FOR SUPPLYING CONNECTION BETWEEN NETWORKS BASED ON POLICY

(71) Applicant: ELECTRONICS AND TELECOMMUNICATIONS RESEARCH INSTITUTE, Daejeon (KR)

(72) Inventors: Ho Sun YOON, Daejeon (KR); Pyung Koo PARK, Daejeon (KR); Ho Yong RYU, Daejeon (KR); Young Soo SHIN, Daejeon (KR); Sung Back HONG, Daejeon (KR)

(21) Appl. No.: 15/044,489

(22) Filed: Feb. 16, 2016

(30) Foreign Application Priority Data
Apr. 15, 2015 (KR) 10-2015-0052941

(51) Int. Cl. H04L 29/06

(52) U.S. Cl. CPC H04L 63/20; H04L 63/029; H04L 63/08; H04L 63/0236

(57) ABSTRACT

A method and an apparatus of integrative network management, which provide connection between private networks and real-time connection according to various policies depending on security or a quality of service (QoS), manages information required to provide the connection, and controls connection by using the managed information in order to defend and cope with various types of cyber attacks and fundamentally invalidate a cyber attack.

### CROSS-REFERENCE TO RELATED APPLICATIONS

This application claims priority to and the benefit of Korean Patent Application No. 10-2015-0052941 filed in the Korean Intellectual Property Office on Apr. 15, 2015, the entire contents of which are incorporated herein by reference.

### BACKGROUND OF THE INVENTION

1. Field of the Invention

The present invention relates to a method and an apparatus for integrative network management, and particularly, to a method and an apparatus for integrative network management for supplying connection between private networks according to security or a quality of service (QoS) policy while using an opened transport network.

2. Description of Related Art

In general, a subscriber access network and a service server farm or a private network are connected through a core network. That is, the core network transfers packets to a destination while obtaining routing information for the subscriber access network and the server farm or the private network. In this case, attackers can perform various types of attacks including DDoS by using opened network addresses. Further, there is a problem in that individual networks are arbitrarily constituted, and as a result, defense for abnormal traffic or detection of traffic to leak information from a server is impossible. In order to solve the problem, an access method is required, which systematically designs the network, configures the network in a previously designed form, and integrates and manages the configured network on the whole.

In a method most widely used for connection between the private networks at present, a virtual private network (VPN) is set by using network address translation (NAT) or a security scheme such as Internet protocol security (IPSec) or transport layer security (TLS). In such a method, resources including an address are managed for each local network, and as a result, tracking is difficult even after the attack is discovered and further, a VPN server address is opened, and as a result, it is necessary to cope with a VPN server attack.

### SUMMARY OF THE INVENTION

The present invention has been made in an effort to provide a method and an apparatus for integrative network management, which provide connection between private networks and real-time connection according to various policies depending on security or a quality of service (QoS), manages information required to provide the connection, and controls connection by using the managed information in order to defend and cope with various types of cyber attacks and fundamentally invalidate a cyber attack.

The technical objects of the present invention are not limited to the aforementioned technical objects, and other technical objects, which are not mentioned above, will be apparently appreciated to a person having ordinary skill in the art from the following description.

An exemplary embodiment of the present invention provides an integrative network management method in a managed network system, including: maintaining in a database user management information for user equipment, configuration management information for managed devices, profile management information for profiles, and setting management information for tunnel setting; providing a service list based on service profiles to the user equipment after completing authentication by referring to the database according to a request of the user equipment; determining, with respect to each service of the service list, whether the corresponding service is a service using a hidden IP address by referring to the database, and updating tunnel usage information depending on setting in a tunnel control system (TCS) with respect to a corresponding tunnel in the database by searching or generating the corresponding tunnel in the database in real time with respect to the service using the hidden IP address.

In the integrative network management method, the tunnel usage information is notified to respective TCSs of an integrative network management apparatus side, a service server side, and the user equipment side in the managed network system to make the integrative network management apparatus side, the service server side, and the user equipment side interwork with each other by passing through a transport network by using a specific tunnel for the hidden IP address according to tunnel control in the TCSs.

In the service using the hidden IP address, for communication through the tunnel among the TCSs, IP addresses of an access gateway connected to the user equipment, the service server, and the user equipment and a security gateway connected to the service server may have random number values generated by a random number generation scheme.

The tunnel usage information may be information for setting traffics having a hidden IP address of the user equipment as a source IP address, a hidden IP address of the security gateway of the service server side as a destination IP address, and a differentiated services codepoint (DSCP) value, which are managed in connection profile information among the profile management information to use a specific tunnel according to the setting.

The updating of the tunnel usage information may include (a) searching, when it is searched that entities for a source TCS and a destination TCS of a corresponding requested tunnel based on service profile information among the profile management information are present in tunnel profile information among the profile management information, an entity of tunnel control information among the setting management information, which includes information including entities of QoS profile information, security profile information, and the tunnel profile information for the source TCS and the destination TCS included in the service profile information; and (b) verifying a state value of the searched entity of the tunnel control information to examine whether the entity is set in the TCS.

The updating of the tunnel usage information may further include: (c) generating the entity including the source TCS and the destination TCS in tunnel profile information among the profile management information when the source TCS and the destination TCS of the requested tunnel are not present in the tunnel profile information; and (d) adding an entity of the tunnel control information including tunnel profile information including entities for the source TCS and the destination TCS searched in step (a) or generated in step (c), the QoS profile information, and the security profile information.

The updating of the tunnel usage information may further include (e) notifying the entity of the tunnel control information to TCSs on the network and receiving a response thereto to reflect the response to the state value of the tunnel control information.

The integrative network management method may further include, after step (e), adding the hidden IP address of the user equipment, the hidden IP address of the security gateway at the service server side, and the DSCP value included in the service profile information to an entity of connection profile information among the profile management information so as to include the hidden IP address of the user equipment, the hidden IP address of the security gateway at the service server side, and the DSCP value included in the service profile information; and adding an entity of tunnel usage information among the setting management information so as to include the added entity of the tunnel control information and the added entity of the connection profile information.

Another exemplary embodiment of the present invention provides an integrative network management apparatus in a managed network system, including: a database storing and managing user management information for user equipment, configuration management information for managed devices, profile management information for profiles, and setting management information for tunnel setting; an authentication server performing authentication by referring to the database according to a request of user equipment; and a control server providing a service list based on service profiles to the user equipment after completing the authentication, determining, with respect to each service of the service list, whether the corresponding service is a service using a hidden IP address by referring to the database, and updating tunnel usage information depending on setting in a tunnel control system (TCS) with respect to a corresponding tunnel in the database by searching or generating the corresponding tunnel in the database in real time with respect to the service using the hidden IP address.

In the integrative network management apparatus, the tunnel usage information is notified to respective TCSs of the integrative network management apparatus side, a service server side, and the user equipment side in the managed network system to make the integrative network management apparatus side, the service server side, and the user equipment side interwork with each other by passing through a transport network by using a specific tunnel for the hidden IP address according to tunnel control in the TCSs.

In the service using the hidden IP address, for communication through the tunnel among the TCSs, IP addresses of an access gateway connected to the user equipment, the service server, and the user equipment and a security gateway connected to the service server may have random number values generated by a random number generation scheme.

The tunnel usage information may be information for setting traffics having a hidden IP address of the user equipment as a source IP address, a hidden IP address of the security gateway of the service server side as a destination IP address, and a differentiated services codepoint (DSCP) value, which are managed in connection profile information among the profile management information to use a specific tunnel according to the setting.

The control server may search, when it is searched that entities for a source TCS and a destination TCS of a corresponding requested tunnel based on service profile information among the profile management information are present in tunnel profile information among the profile management information, an entity of tunnel control information among the setting management information, which includes information including entities of QoS profile information, security profile information, and the tunnel profile information for the source TCS and the destination TCS included in the service profile information and thereafter, verify a state value of the searched entity of the tunnel control information to examine whether the entity is set in the TCS.

The control server may generate the entity including the source TCS and the destination TCS in tunnel profile information among the profile management information when the source TCS and the destination TCS of the requested tunnel are not present in the tunnel profile information and add an entity of the tunnel control information including tunnel profile information including entities for the source TCS and the destination TCS which are searched or generated, the QoS profile information, and the security profile information.

The control server may notify the entity of the tunnel control information to TCSs on the network and receive a response thereto to reflect the response to the state value of the tunnel control information.

The control server may add the hidden IP address of the user equipment, the hidden IP address of the security gateway at the service server side, and the DSCP value included in the service profile information to an entity of connection profile information among the profile management information and add an entity of tunnel usage information among the setting management information so as to include the added entity of the tunnel control information and the added entity of the connection profile information.

According to exemplary embodiments of the present invention, a method and an apparatus for integrative network management can define various profiles based on a policy and connect a subscriber-side access network, an authentication and control server farm, and a service farm and a data center providing a service by using various tunnels by means of a database constructed so that a specific user and a specific service use a specific tunnel. The tunnel can have various forms according to a QoS and a security policy and various tunnels can be used according to the user or a type of service.

In the method and an apparatus for integrative network management according to the present invention a method can be provided, which can search the tunnel in real time by using information constructed in the database when a predetermined IP address such as a hidden address is used or generate and use a new tunnel when the search is unsuccessful.

In the method and an apparatus for integrative network management according to the present invention the tunnel is used between tunnel control systems (TCSs) to use the conventional transport network without modification.

In the method and an apparatus for integrative network management according to the present invention, resources including an address are managed for each local network, a profile according to the security or QoS policy is managed, the tunnel is set depending on a profile defining the policy, and the set tunnel is managed for each user and service to search and generate the tunnel in real time when there is no connectable tunnel, thereby using a tunnel having various characteristics for each user and service. In such a scheme, the network can be efficiently managed and used and it is possible to cope with various types of cyber attacks. That is, all traffic which does not use a specific tunnel can be filtered to improve safety for information leakage from a server or a cyber attack such as DDoS. In particular, even when an address of a VPN server is a predetermined address, since connection is provided between private networks, it is possible to fundamentally defend the attack against the VPN server.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram for describing an integrative network management apparatus in a managed network system according to an exemplary embodiment of the present invention.

FIG. 2 is a diagram for describing components of a database in FIG. 1.

FIG. 3 is a diagram for describing user management information managed in the database in FIG. 1.

FIG. 4 is a diagram for describing configuration management information managed in the database of FIG. 1.

FIG. 5 is a diagram for describing profile management information managed in the database of FIG. 1.

FIG. 6 is a diagram for describing setting management information managed in the database of FIG. 1.

FIG. 7 is a flowchart for describing an automatic tunnel generating process in an integrative network management apparatus according to an exemplary embodiment of the present invention.

FIG. 8 is a diagram for describing one example of a method for implementing an integrative network management apparatus on a managed network according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a constituent element from another constituent element, but nature or an order of the constituent element is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal or excessively formal meanings unless clearly defined in the present application.

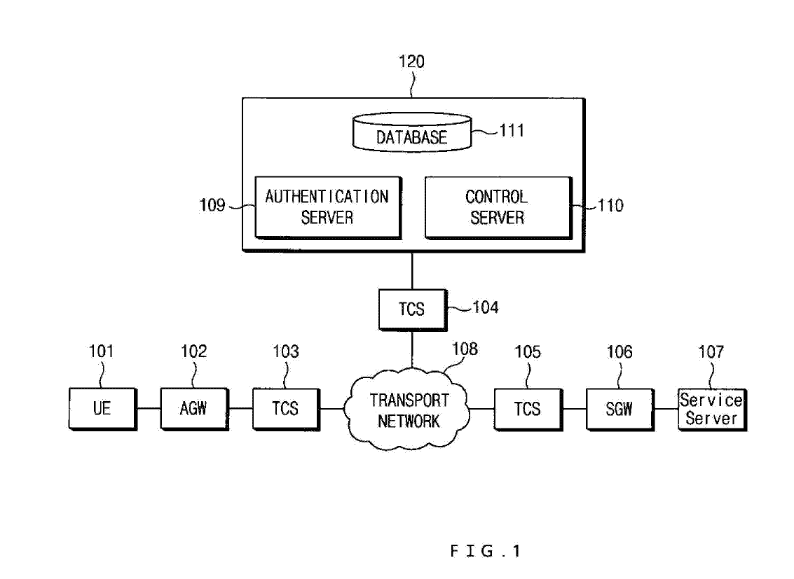

FIG. 1 is a diagram for describing an integrative network management apparatus 120 in a managed network system according to an exemplary embodiment of the present invention. Herein, a managed network means a network that globally manages various component devices, and a user and a service on a network in order to cope with various types of cyber attacks.

Referring to FIG. 1, the integrative network management apparatus 120 according to the exemplary embodiment of the present invention includes an authentication server 109 for authentication, a control server 110 for managing the network, and a database 111 for managing various information for authentication or control. The integrative network management apparatus 120, user equipment (UE)(s) 101, and a service server(s) 107 for providing a service may mutually interwork with each other through a transport network 108 for transferring packets on the managed network illustrated in FIG. 1. The integrative network management apparatus 120 may interwork with the user equipment(s) 101 or the service server(s) 107 through the transport network 108 according to tunnel control for passing through the transport network 108 of a tunnel control system (TCS) 104.

The user equipment(s) 101 may interwork with the integrative network management apparatus 120 or the service server 107 through the transport network 108 according to access control of an access gateway (AGW) 102 and the tunnel control for passing through the transport network 108 of the TCS 103. The access gateway 102 controls access of the user equipment(s) 101 by managing an IP address pool of the user equipment(s) 101. The user equipment 101 mentioned in the present invention may be a mobile terminal such as a smart phone, a notebook PC, a tablet PC, or the like and in some cases, the user equipment 101 may be a personal digital assistant (PDA), a portable multimedia player (PMP), or the like and besides, may include all electronic devices in which mobile communications (e.g., CDMA, WCDMA, LTE, and the like) or Internet communications (e.g., WiBro, WiFi, and the like) may be supported.

The service server(s) 107 may interwork with the integrative network management apparatus 120 or the user equipment(s) 101 through the transport network 108 according to security access control of a security gateway (SGW) 106 and the tunnel control for passing through the transport network 108 of the TCS 105. The security gateway (SGW) 106 may control the access by using a security scheme such as Internet protocol security (IPSec) or transport layer security (TLS). The service server(s) 107 as a server that provides various types of service including a mobile communication service, a digital multimedia service, an Internet service, and the like on the network may be one server or a service server farm or a data center type.

As such, the TCSs 103, 104, and 105 that perform the tunnel control, for passing through the transport network 108 for each of the user equipment(s) 101, the service server(s) 107, and the integrative network management apparatus 120 control the packet to pass through the transport network 108 by using various types of tunnels including IP-in-IP, generic routing encapsulation (GRE), the IPSec, and the like. The tunnel is used so as to allow the packet to pass through the transport network 108 because IP addresses of all devices that are present at a rear end of the TCSs 103, 104, and 105 are not opened to the transport network 108. That is, since IP addresses allocated to all devices managed by the control server 110 are not opened to the transport network 108, general packet forwarding is impossible and the tunnel is used in order to solve such a problem.

The tunnel is, in advance, set among the TCSs 103, 104, and 105 to minimize tunnel setting information which are exchanged between the control server 110 and the TCSs 103, 104, and 105. However, when a hidden address is used in order to hide the service server 107 and the security gateway (SGW) 106, the tunnel needs to be generated in real time.

Hereinafter, in the present invention, disclosed is a method for defining information for controlling and managing the tunnel, user information, service information which the user may access, device information, and the like according to the policy and searching or generating the tunnel in real time.

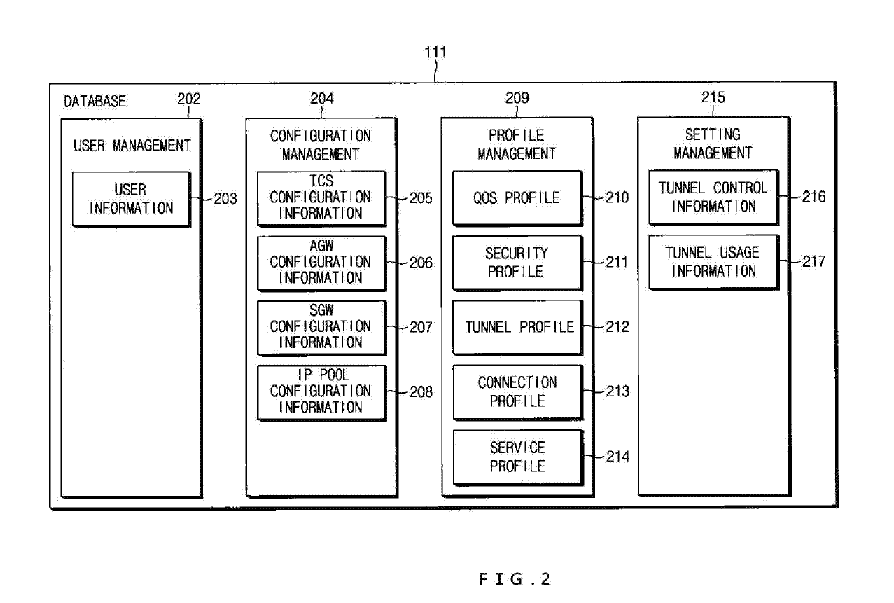

FIG. 2 is a diagram for describing components of a database 111 in FIG. 1. Referring to FIG. 2, the database 111 may store and manage use management information 202 for managing information associated with the user, configuration management information 204 for managing information associated with the managed devices, profile management information 209 for managing information associated with various profiles, setting management information 215 for managing information associated with tunnel setting, and the like in a storage means such as a memory, or the like.

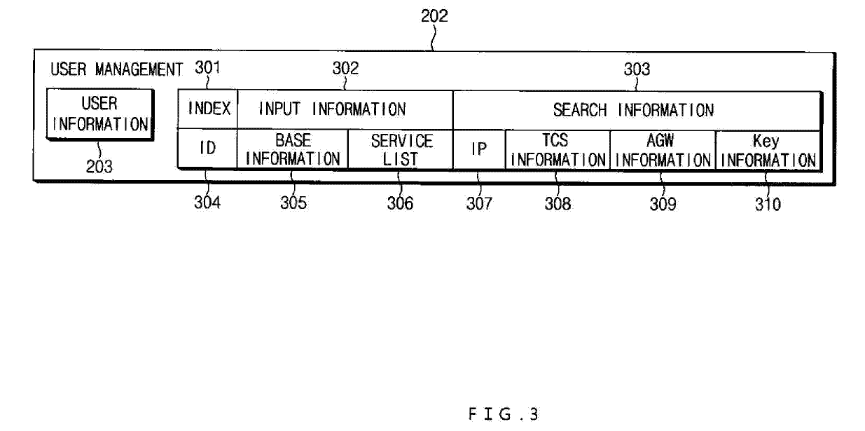

The user management information 202 includes the user information 203 for managing the user and may include, for example, user identification (ID), base information, an IP address, and the like associated with the user equipment(s) 101 (see FIG. 3).

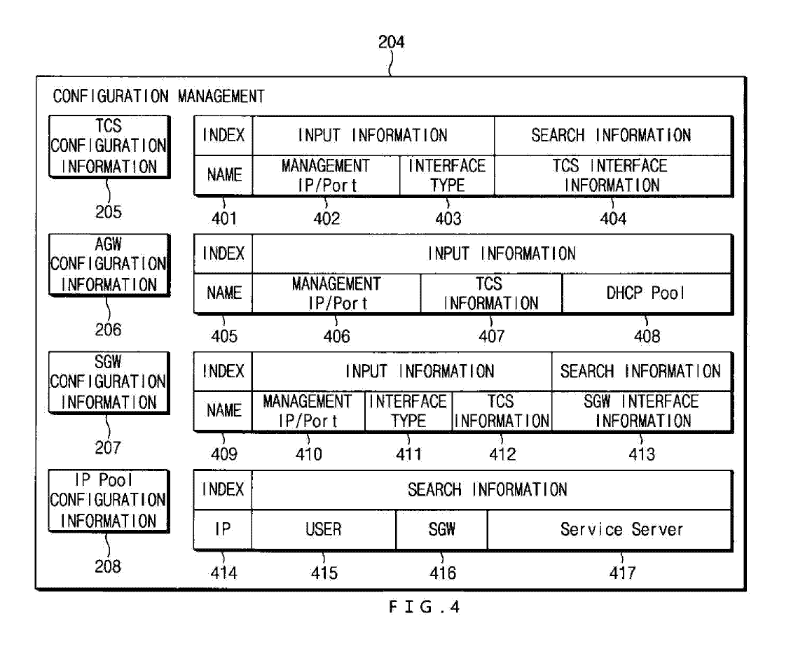

The configuration management information 204 includes management device and resource information and may include, for example, include TCS (103/104/105) configuration information 205, AGW configuration information 206, SOW configuration information, 207, and IP address pool configuration information 208 (see FIG. 4). An IP address pool means a hidden IP address pool and the hidden IP address may be determined by using a random number value which is arbitrarily generated and selected.

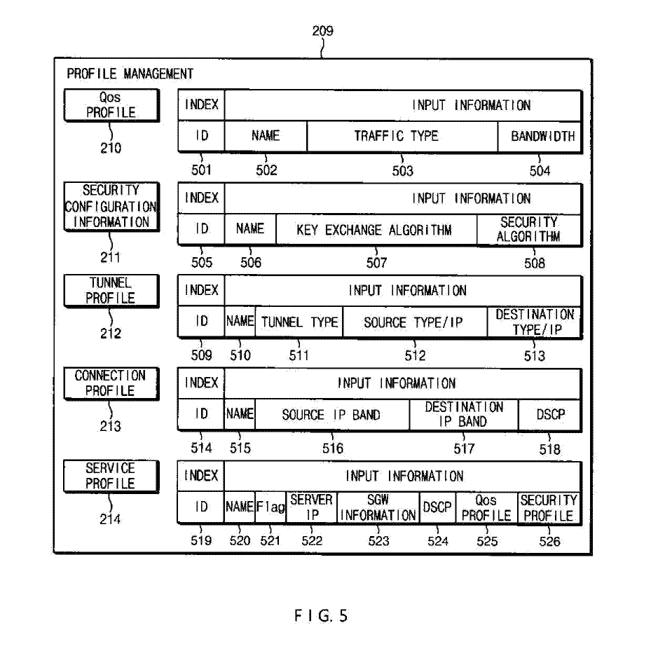

The profile management information 209 includes information associated with various profiles, which includes various profile information for managing a characteristic of the tunnel, profile information for allocating the tunnel according to the policy, and profile information associated with the service and may include, for example, QoS profile information 210 for defining the QoS of the tunnel, security profile information 211 for defining a security characteristic of the tunnel, tunnel profile information 212 for defining a characteristic of the tunnel, connection profile information 213 for defining a characteristic of traffic to actually use the tunnel, service profile information 214 for defining a characteristic of the service, and the like (see FIG. 5).

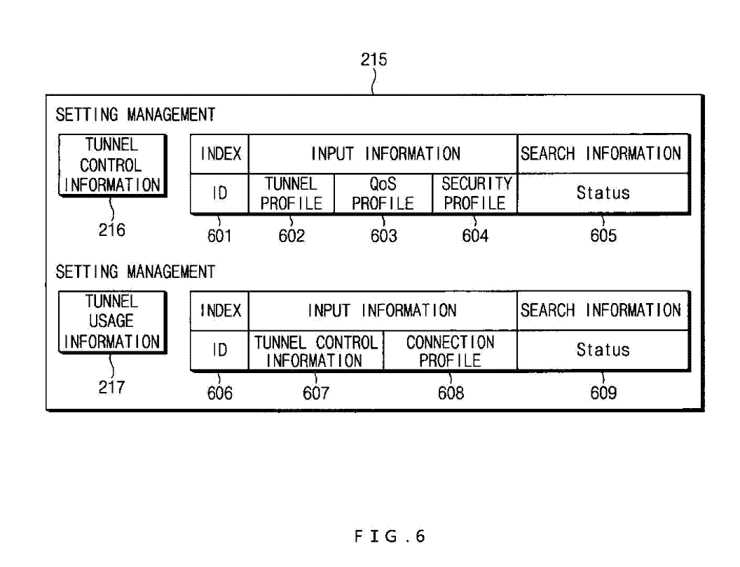

The setting management information 215 includes various management information for setting the tunnel and defining the traffic to use the tunnel and may include, for example, tunnel control information 216 for setting the tunnel, tunnel usage information 217 for setting the traffic to use the set tunnel, and the like (see FIG. 6).

FIG. 3 is a diagram for describing user management information 202 managed in the database 111 in FIG. 1.

Referring to FIG. 3, the user management information 202 includes the user information 203 for managing the user and for example, includes an index 301 such as a user ID used for search, or the like, input information 302 input by an operator or input according to an operating result of the device 120, and search information 303 which is a result not input by the operator but obtained by performing a specific procedure or a value searched and read from the database 111.

Herein, the input information 302 includes base information 305 on the user, such as a name, a birthday, an occupation, and the like, a service list 306 which the corresponding user may access, and the like. The service list 306 may include a service profile ID 519 or a service profile name 520 of the service profile information 214 included in FIG. 5.

The search information 303 includes an IP address 307 used in the user equipment 101, TCS information 308 which is present on an upper layer of the AGW 102 accessed by the user equipment 101, AGW 102 information 309 accessed by the user equipment 101, key information 310 such as a key for authentication or a key used for protecting a message of a wireless section, and the like. The IP address 307 may be an IP address used as an ID concept or an IP address allocated by using a dynamic host configuration protocol (DHCP), or the like to be used in the network.

The user information 203 is not output through a display device, and the like at the time of actually searching the database 111 and even when the user information 203 is stored in the database 111, the user information 203 may be encrypted and stored and managed.

FIG. 4 is a diagram for describing configuration management information 204 managed in the database 111 in FIG. 1.

Referring to FIG. 4, the configuration management information 204 may include the managed device and resource information and may include, for example, include the TCS configuration information 205, the AGW configuration information 206, the SOW configuration information, 207, and the IP address pool configuration information 208. An IP address pool means a hidden address pool and the hidden address may be determined by using a random number value which is arbitrarily generated and selected.

For example, the TCS configuration information 205 includes an index such as a TCS (103/104/105) device name 401 used for the search and as input information input by the operator or input according to an operating result of the device 120, includes a management IP address and port number 402 for controlling the TCS (103/104/105) and an interface type 403 of the TCS (103/104/105). Further, the TCS configuration information 205 as search information which is a result not input by the operator but obtained by performing a specific procedure or a value searched and read from the database 111 includes interface information 404 of the TCS. When the TCS (103/104/105) is booted, the TCS (103/104/105) uploads the interface information held thereby to the control server 110 and the interface information is stored in the form of the interface information 404 of the TCS. That is, according to the interface information received by the control server 110, the operator may divide the interface information into a subscriber interface, a tunnel interface, a service interface, a control interface, and the like through a predetermined display device, and the like and the divided information is stored in the form of the interface type 403 of the TCS.

The AGW configuration information 206 includes an index such as an AGW (102) device name 405 used for the search and as input information input by the operator or input according to the operating result of the device 120, includes a management IP address and port number 406 for controlling the AGW, TCS 103 information 407 which is present on an upper layer of the AGW 102, DHCP pool information 408 which the AGW 102 refers to, and the like. The TCS information 407 may include the TCS device name such as 401, and the like. When the user equipment 101 requests a network IP address to the AGW 102, the AGW 102 may allocate the network IP address by referring to the DHCP pool information 408.

The SGW configuration information 207 includes an index such as an SGW (106) device name 409 used for the search and as input information input by the operator or input according to the operating result of the device 120, includes a management SGW IF address and port number 410 for managing the SGW, an interface type 411 of the SGW 106 divided into the TCS 105 interface and the service server 107 interface, TCS 105 information 412 positioned on an upper layer of the SGW 106, and the like. Further, the SGW configuration information 207 as search information which is a result not input by the operator or obtained by performing a specific procedure and a value searched and read from the database 111 includes interface information 413 held by the SOW 106. At the time when the SOW 106 is booted, the SOW 106 transfers the interface information 413 to the control server 110.

The IP address pool configuration information 208 includes an index such as an IP address 414 of the ID concept used for the search, or the like and as search information which is a result not input by the operator but obtained by performing the specific procedure or a value searched and read from the database 111, includes corresponding user information 415 when the corresponding IP address 414 is allocated to the user equipment 101, corresponding SGW information 416 when the corresponding IP address 414 is allocated to the SOW 106, corresponding service server information 417 when the corresponding IP address 414 is allocated to the service server 107, and the like. That is, according to which device among the user equipment 101, the SGW 106, and the service server 107 414 which is one IP address is allocated to, values of 415, 416, and 417 may be searched.

FIG. 5 is a diagram for describing profile management information 209 managed in the database 111 of FIG. 1.

Referring to FIG. 5, the profile management information 209 includes information associated with various profiles, which include various profile information for managing a characteristic of the tunnel, profile information for allocating the tunnel according to the policy, and profile information associated with the service and may include, for example, QoS profile information 210 for defining the QoS of the tunnel, security profile information 211 for defining a security characteristic of the tunnel, tunnel profile information 212 for defining a characteristic of the tunnel, connection profile information 213 for defining a characteristic of traffic to actually use the tunnel, service profile information 214 for defining a characteristic of the service, and the like.

The QoS profile information 210 for defining the QoS of the tunnel includes an index such as an ID 501 of a QoS profile used for the search, and the like and as input information input by the operator or input according to the operating result of the device 120, includes a QoS profile name 502, a traffic type 503 such as a guaranteed rate (GR), maximum rate (MR), available rate (AR), composite rate (CR), or the like, a bandwidth 504, and the like. As the QoS profile, various values may be used according to the QoS policy.

The security profile information 211 for defining the security characteristic of the tunnel includes an index such as an ID 505 of a security profile used for the search, and the like and as input information input by the operator or input according to the operating result of the device 120, may include a security profile name 506, a key exchange algorithm type 507, an encryption or decryption algorithm type 508, and the like. The key exchange algorithm type 507 may represent a specific protocol such as Internet key exchange (IKE) and represent an encryption or decryption algorithm (e.g., DES, 3-DES, AES, SEED, and the like) used in the specific protocol such as the IKE. The encryption or decryption algorithm type 508 as an algorithm for protecting the message may represent a specific scheme such as authentication header/encapsulating security payload (AH/ESP) and represent an encryption or decryption algorithm used in the AH/ESP, and include a hash algorithm type as necessary. That is, the encryption or decryption algorithm type 508 may be defined according to the security policy or the QoS policy which is detailed values of the security profile information 211 and the QoS profile information 210.

The tunnel profile information 212 for defining the characteristic of the tunnel includes an index such as an ID 509 of a tunnel profile used for the search, and the like and as input information input by the operator or input according to the operating result of the device 120, includes a tunnel name 510, a tunnel type 511 representing a tunnel type, such as IP-in-IP, IPSec, GRE, and the like, a source IP address 512, a destination IP address 513 of the tunnel, and the like. That is, the tunnel profile information 212 manages information associated with the type of the tunnel and a start point and a destination point of the tunnel.

The connection profile information 213 for defining the characteristic of the traffic to actually use the tunnel includes an index such as an ID 514 of a connection profile used for the search, and the like and as input information input by the operator or input according to the operating result of the device 120, may include a name 515 of connection information, a source IP address band 516, a destination IP address band 517, a differentiated services codepoint (DSCP) value 518 for determining a processing method of an IP packet, and the like. As such, the connection profile information 213 includes information for determining the traffic to use the specific tunnel. That is, the connection profile information 213 is provided to the TCS (103/104/105) so as to determine a tunnel to be used by the packet by using a source IP address, a destination IP address, and a DSCP value included in an IP header of the packet. In this case, in the TCS 103/104/105, when the tunnel information is searched by using the source IP address band 516, the destination IP address band 517, and the DSCP value 518 as a search index, a table of the corresponding searched tunnel information may be managed. Of course, a longest prefix match scheme may be used at the time of searching the source IP address band 516 and the destination IP address band 517.

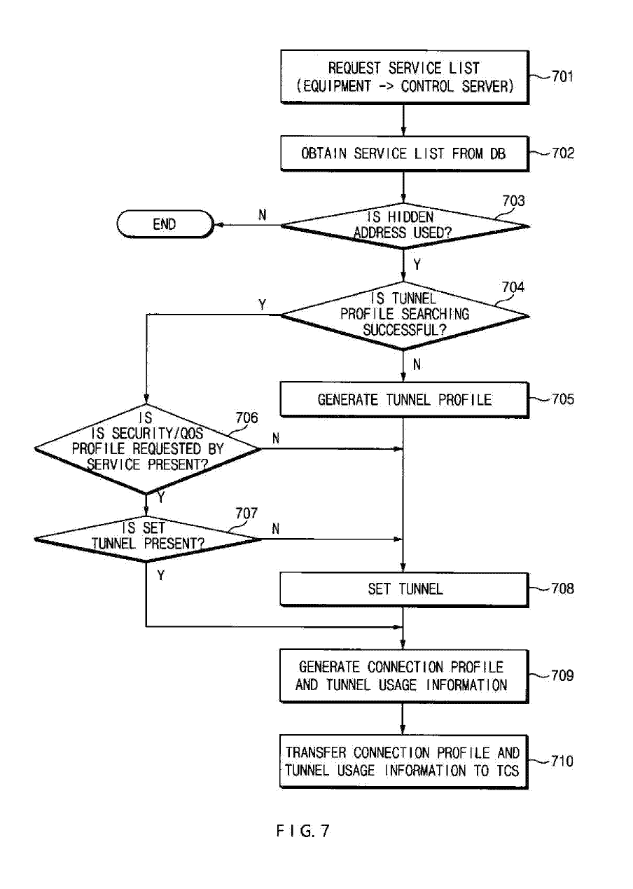

The service profile information 214 for defining the characteristic of the service includes an index such as an ID 519 of the service profile used for the search, and the like and as input information input by the operator or input according to the operating result of the device 120, includes a name 520 of the service profile, a flag value 521 indicating whether the corresponding service is the service using the hidden IP address, an IP address 522 (e.g., when the flag value 521 indicates that the corresponding service is the service using the hidden IP address, the flag value 521 includes an IP address of the actual service server 107 and a hidden IP address selecting a predetermined IP address value in the IP pool configuration information 208) of the service server 107, an SOW 106 device name 409 of the SOW configuration information 207, SOW information 523 (e.g., when the service uses the hidden IP address, the service includes all hidden IP addresses selecting the predetermined IP address value in the IP pool configuration information 208 other than the actual IP address) such as the SOW 106 IP address 410, or the like, a DSCP value 524 which the user equipment 101 will use at the time of generating the packet, a QoS profile 525, a security profile 526, and the like. Herein, the DSCP value 524 is a value which the user equipment 101 will use at the time of generating the packet and after the authentication server 109 completes authentication of the user equipment 101, the control server 110 transfers a service list which the user equipment 101 may access to the user equipment 101 based on the service profile information 214 and in this case, the DSCP value 524 is included in the transferred service list. When the user equipment 101 uses a specific service, the DSCP value 524 is included in the packet for the service and the DSCP value 524 is used when a tunnel to be used for a specific packet is searched in the TCS 103/104/105, and as a result, the QoS policy may be applied to the specific service. The QoS profile 525 and the security profile 526 are values to be used at the time of searching or generating the tunnel when a tunnel suitable for the packet may not be searched in the TCS 103/104/105. This will be described in more detail in description of FIG. 7 given below. When a hidden address is used, hidden IP address and actual IF address information of the service server 107 and hidden IP address and actual IP address information of the SOW 106 need to be transferred to the SGW 106. The information may be obtained by searching the service profile 214.

FIG. 6 is a diagram for describing setting management information 215 managed in the database 111 of FIG. 1.

Referring to FIG. 6, the setting management information 215 may include various management information for setting the tunnel and defining the traffic to use the tunnel and may include, for example, tunnel control information 216 for setting the tunnel, tunnel usage information 217 for setting the traffic to use the set tunnel, and the like.

The tunnel control information 216 for setting the tunnel includes an index such as an ID 610 of the tunnel control information used for the search and as input information input by the operator or input according to the operating result of the device 120, includes a tunnel profile ID 602 like 509, a QoS profile ID 603 like 501, a security profile ID 604 like 505, and the like. The profile information 602, 603, and 604 is used to represent the characteristic of the tunnel. That is, the type, the start point, and the destination point of the tunnel may be represented through the tunnel profile ID 602 and a QoS feature and a security feature of a specific tunnel may be represented through the QoS profile ID 603 and the security profile ID 604, respectively. When the profile information 602, 603, and 604 is transferred to the TCS 103/104/105, the corresponding TCS generates the tunnel according to three profiles. Further, the tunnel control information 216 as search information which is a result not input by the operator but obtained by performing a specific procedure or a value searched and read from the database 111 may include a state value 605 for verifying whether the tunnel is set in the TCS.

The tunnel usage information 217 for setting the traffic that will use the set tunnel includes an index such as an ID 606 of tunnel usage information used for the search, and the like, and? as input information input by the operator or input according to the operating result of the device 120, includes tunnel control information 607 set like 601, connection profile information 608 like 514, and the like. Further, the tunnel usage information 217 as search information which is a result not input by the operator but obtained by performing a specific procedure or a value searched and read from the database 111 may include a state value 609 for verifying whether the tunnel usage information 217 is applied to the current TCS. When normal processing is achieved in the TCS 103/104/105, the processing result is transferred to the control server 110 and the control server 110 reflects the state value 609 to the database 111. The tunnel usage information 217 is information set for the traffics having the source IP address band 516, the destination IP address band 517, and the DSCP value 518 defined in the connection profile information 213 to use a set specific tunnel.

FIG. 7 is a flowchart for describing an automatic tunnel generating process in an integrative network management apparatus 120 according to an exemplary embodiment of the present invention. Hereinafter, a procedure for the integrative network management apparatus 120 to automatically search or generate the tunnel will be described. When the specific service uses the hidden IP address, all of the user equipment 101 IP address, the AGW 102 IP address, the SGW 106 IP address, and the service server IP address 107 use a hidden IP address having a predetermined random number value. In this case, for communication through a specific tunnel between the TCS and the TCS, the tunnel for the hidden IP address needs to be searched or generated in real time. FIG. 7 illustrates, in detail, a procedure for searching or generating the tunnel in real time.

In order to search or generate the tunnel in real time, first, for example, the user equipment 101 request the service list to the control server 110 (701). As a result, after the authentication server 109 completes authentication for the user equipment 101 by referring to the user management information of the database 111, the control server 110 obtains the service list which the corresponding user equipment 101 may access based on the service profile information 214 by searching the database 111 to transfer the service list to the user equipment 101 (702).

Next, the control server 110 determines whether the corresponding service is the service using the hidden IP address by referring to the flag value 521 of the service profile information 214 with respect to each service of the obtained service list (703). In this case, when the corresponding service does not use the hidden IP address, the procedure of searching or setting the tunnel in real time is omitted and when the corresponding service uses the hidden IP address, the procedure of searching or setting the tunnel in real time is performed with respect to the corresponding service as described above.

When the corresponding service uses the hidden IP address in step 703 as described above, the control server 110 searches whether a requested tunnel based on the service profile information 214 is present in the tunnel profile information 212 (that is, whether source TCS and destination TCS of the requested tunnel are present) (704). For example, the control server 110 may obtain the SOW information 523 of the service using the hidden IP address in the service profile 214 and obtain the TCS information 412 in the SOW information 523 and the TCS corresponding to the TCS information 412 obtained as described above becomes a destination or a source of the tunnel. Further, the control server 110 may search the TCS information 407 of the AGW configuration information 206 from the AGW 102 information 309 accessed by the user equipment 101 and the TCS information obtained as such becomes the destination or source of the tunnel. That is, when the packet is transferred from the user equipment 101 to the service server 107, the TCS 103 positioned at the user equipment 101 side becomes the source of the tunnel and the TCS 105 positioned at the service server 107 side becomes the destination of the tunnel. When the packet is transferred in an inverse direction, the source and the destination of the tunnel are determined contrary to this. A tunnel profile entity suitable for the corresponding service is searched according to directionality in the tunnel profile information 212 by using the source and destination information of the tunnel obtained as such (704).

When successful search is achieved that the tunnel requested based on the service profile information 214 is present in the entity of the tunnel profile information 212, the control server 110 performs a procedure 706 and when the corresponding search is unsuccessful, the control server 110 performs a procedure 705.

When the corresponding search is unsuccessful (704), the control server 110 generates the entity of the tunnel profile information 212 for the corresponding requested tunnel (the tunnel of the corresponding source TCS and the destination TCS) in which the search is unsuccessful (705).

When the corresponding search is successful (704), the control server 110 searches entities of the QoS profile information 525, the security profile information 526, and the corresponding tunnel control information which coincides with a tunnel profile entity searched in a procedure 704 which are included in the service profile 214 in the tunnel control information 216 (706). When entities of the tunnel control information 216 in which all three information (525, 526, and the tunnel profile entity) coincides with each other are found, the search is successful and if not, it is determined that the search is unsuccessful. When the search is successful, a procedure 707 is performed and when the search is unsuccessful, a procedure 708 is performed.

The control server 110 verifies the state value 605 to examine whether the entity of the searched tunnel control information is actually set in the TCS 103/104/105 in the procedure 707. When the control server 110 verifies that the entity is set in the TCS in the procedure 707, this means that the tunnel to transfer the traffic has been already set in the TCS.

The control server 110 uses as the tunnel profile (one of 212) the entity of the tunnel profile information 212 searched in the procedure 704 or generated through the procedure 705 and uses as the QoS profile (one of 210) and the security profile (one of 211) the entities of the QoS profile information 525 and the security profile information 526 used in the procedure 706 for tunnel setting for the corresponding service a procedure 708. As a result, the control server 110 additionally generates the tunnel control information 216 (one entity) by reflecting the profile information to become the information of 602, 603, and 604 to complete the tunnel generation and transfers the information to the TCS 103/104/105. The TCS 103/104/105 successfully completes setting the tunnel control depending on the tunnel generation information and thereafter, notifies the result to the control server 110 and the control server 110 reflects the result to the state value of 605.

When the tunnel setting for the corresponding service is performed as such, the control server 110 adds the corresponding entity to the connection profile information 213 by using the hidden IP address and newly adds the tunnel control information of 607 depending on the corresponding tunnel control information obtained through the procedure 708 and the connection profile information of 608 depending on the entity of the added connection profile information to the tunnel usage information 217 to update generation of the corresponding entity (709). That is, one entity is added to the connection profile information 213 with the hidden IP address (e.g., source IP address) of the user equipment 101 and the hidden IP address (e.g., destination IP address) of the SOW 106, and the DSCP value 524 included in the service profile 214 and one entity profile is added even to the inverse direction (a direction in which the SGW is the source and the user equipment is the destination).

The control server 110 adds one entity of the tunnel usage information 217 to the tunnel control information 216 toward the TCS 105 at the service server 107 side from the TCS 103 at the user equipment 101 side searched through the procedure 707 or obtained through the procedure 708 and the connection profile information 213 obtained through such a procedure (709). Also, the entity of the tunnel usage information 217 is added even to the inverse direction (a direction toward the TCS 103 at the user equipment 101 side from the TCS 105 at the service server 107 side).

The entity of the updated tunnel usage information 217, which includes the generated entity of the connection profile information 213 is transferred to the TCS to perform communication through the corresponding specific tunnel (710). When normal processing is achieved in the TCS, the processing result is transferred to the control server 110 and the control server 110 reflects the result to the state value 609 of the database 111.

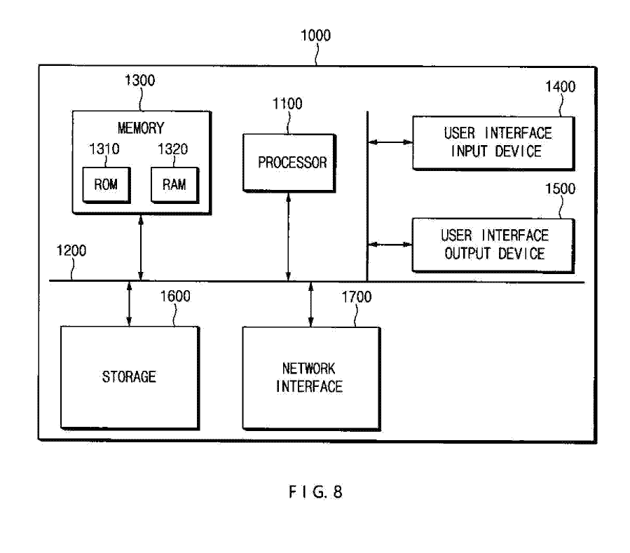

FIG. 8 is a diagram for describing one example of a method for implementing an integrative network management apparatus 120 on a managed network according to an exemplary embodiment of the present invention. The integrative network management apparatus 120 according to the exemplary embodiment of the present invention may be constituted by hardware, software, or combinations thereof. For example, the integrative network management apparatus 120 may be implemented as a computing system 1000 illustrated in FIG. 8.

The computing system 1000 may include at least one processor 1100, a memory 1300, a user interface input device 1400, a user interface output device 1500, a storage 1600, and a network interface 1700 connected through a bus 1200. The processor 1100 may be a semiconductor device that executes processing of commands stored in a central processing unit (CPU) or the memory 1300 and/or the storage 1600. The memory 1300 and the storage 1600 may include various types of volatile or non volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM memory, a flash memory, a ROM memory, an EPROM memory, an EEPROM memory, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in user equipment. As yet another method, the processor and the storage medium may reside in the user equipment as individual components.

As described above, the integrative network management apparatus 120 according to the present invention can define various profiles based on a policy and connect a user or subscriber-side access network, the authentication and control server farm, and the service farm and a data center providing the service by using various tunnels by means of the database 111 constructed so that a specific user and a specific service use a specific tunnel. The tunnel can have various forms according to a QoS and a security policy and various tunnels can be used according to the user or a type of service. Further, when the predetermined IP address such as the hidden address is used, the tunnel is searched in real time by using the information constructed in the database or when the search is unsuccessful, a method which can generate and use a new tunnel may be provided and further, the existing transport network may be used without modification by using the tunnel between the tunnel control systems (TCSs).

In the integrative network management apparatus 120 according to the present invention, resources including an address are managed for each local network, a profile according to the security or QoS policy is managed, the tunnel is configured depending on a profile defining the policy, and the configured tunnel is managed for each user and service to search and generate the tunnel in real time when there is no connectable tunnel, thereby using a tunnel having various characteristics for each user and service. In such a scheme, the network can be efficiently managed and used and it is possible to cope with various types of cyber attacks. That is, all traffic which does not use a specific tunnel can be filtered to improve safety for information leakage from a server or a cyber attack such as DDoS. In particular, even when an address of a VPN server is a predetermined address, since connection is provided between private networks, it is possible to fundamentally defend the attack against the VPN server.

The above description just illustrates the technical spirit of the present invention and various modifications and transformations can be made to those skilled in the art within a scope without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirits in the equivalent range are intended to be embraced by the present invention.

What is claimed is:

1. An integrative network management method in a managed network system, the method comprising:
maintaining in a database user management information for user equipment, configuration management information for managed devices, profile management information for profiles, and setting management information for tunnel setting;
providing a service list based on service profiles to the user equipment after completing authentication by referring to the database according to a request of the user equipment;
determining, with respect to each service of the service list, whether the corresponding service is a service using a hidden IP address by referring to the database; and
updating tunnel usage information depending on setting in a tunnel control system (TCS) with respect to a corresponding tunnel in the database by searching or generating the corresponding tunnel in the database in real time with respect to the service using the hidden IP address.

2. The integrative network management method of claim 1, wherein the tunnel usage information is notified to respective TCSs of an integrative network management apparatus side, a service server side, and the user equipment side in the managed network system to make the integrative network management apparatus side, the service server side, and the user equipment side interwork with each other by passing through a transport network by using a specific tunnel for the hidden IP address according to tunnel control in the TCSs.

3. The integrative network management method of claim 2, wherein in the service using the hidden IP address, for communication through the tunnel among the TCSs, IP addresses of an access gateway connected to the user equipment, the service server, and the user equipment and a security gateway connected to the service server have random number values generated by a random number generation scheme.

4. The integrative network management method of claim 1, wherein the tunnel usage information is information for setting traffics having a hidden IP address of the user equipment as a source IP address, a hidden IP address of the security gateway of the service server side as a destination IP address, and a differentiated services codepoint (DSCP) value, which are managed in connection profile information among the profile management information to use a specific tunnel according to the setting.

5. The integrative network management method of claim 1, wherein the updating of the tunnel usage information includes:
(a) searching, when it is searched that entities for a source TCS and a destination TCS of a corresponding requested tunnel based on service profile information among the profile management information are present in tunnel profile information among the profile management information, an entity of tunnel control information among the setting management information, which includes information including entities of QoS profile information, security profile information, and the tunnel profile information for the source TCS and the destination TCS included in the service profile information; and
(b) verifying a state value of the searched entity of the tunnel control information to examine whether the entity is set in the TCS.

6. The integrative network management method of claim 5, wherein the updating of the tunnel usage information further includes:
(c) generating the entity including the source TCS and the destination TCS in tunnel profile information among the profile management information when the source TCS and the destination TCS of the requested tunnel are not present in the tunnel profile information; and
(d) adding an entity of the tunnel control information including tunnel profile information including entities for the source TCS and the destination TCS searched in step (a) or generated in step (c), the QoS profile information, and the security profile information.

7. The integrative network management method of claim 6, wherein the updating of the tunnel usage information further includes (e) notifying the entity of the tunnel control information to TCSs on the network and receiving a response thereto to reflect the response to the state value of the tunnel control information.

8. The integrative network management method of claim 7, further comprising:
after step (e),
adding the hidden IP address of the user equipment, the hidden IP address of the security gateway at the service server side, and the DSP value included in the service profile information to an entity of connection profile information among the profile management information so as to include the hidden IP address of the user equipment, the hidden IP address of the security gateway at the service server side, and the DSCP value included in the service profile information; and
adding an entity of tunnel usage information among the setting management information so as to include the added entity of the tunnel control information and the added entity of the connection profile information.

9. An integrative network management apparatus in a managed network system, the apparatus comprising:
a database storing and managing user management information for user equipment, configuration management information for managed devices, profile management information for profiles, and setting management information for tunnel setting;
an authentication server performing authentication by referring to the database according to a request of user equipment; and
a control server providing a service list based on service profiles to user equipment after completing the authentication, determining, with respect to each service of the service list, whether the corresponding service is a service using a hidden IP address by referring to the database, and updating tunnel usage information depending on setting in a tunnel control system (TCS) with respect to a corresponding tunnel in the database by searching or generating the corresponding tunnel in the database in real time with respect to the service using the hidden IP address.

10. The integrative network management apparatus of claim 9, wherein the tunnel usage information is notified to respective TCSs of the integrative network management apparatus side, a service server side, and the user equipment side in the managed network system to make the integrative network management apparatus side, the service server side, and the user equipment side interwork with each other by passing through a transport network by using a specific tunnel for the hidden IP address according to tunnel control in the TCSs.

11. The integrative network management apparatus of claim 10, wherein in the service using the hidden IP address, for communication through the tunnel among the TCSs, IP addresses of an access gateway connected to the user equipment, the service server, and the user equipment and a security gateway connected to the service server have random number values generated by a random number generation scheme.

12. The integrative network management apparatus of claim 9, wherein the tunnel usage information is information for setting traffics having a hidden IP address of the user equipment as a source IP address, a hidden IP address of the security gateway of the service server side as a destination IP address, and a differentiated services codepoint (DSCP) value, which are managed in connection profile information among the profile management information to use a specific tunnel according to the setting.

13. The integrative network management apparatus of claim 9, wherein the control server searches, when it is searched that entities for a source TCS and a destination TCS of a corresponding requested tunnel based on service profile information among the profile management information are present in tunnel profile information among the profile management information, an entity of tunnel control information among the setting management information, which includes information including entities of QoS profile information, security profile information, and the tunnel profile information for the source TCS and the destination TCS included in the service profile information and thereafter,
verifies a state value of the searched entity of the tunnel control information to examine whether the entity is set in the TCS.

14. The integrative network management apparatus of claim 13, wherein the control server generates an entity including the source TCS and the destination TCS in tunnel profile information among the profile management information when the source TCS and the destination TCS of the requested tunnel are not present in the tunnel profile information and
adds an entity of the tunnel control information including tunnel profile information including entities for the source TCS and the destination TCS which are searched or generated, the QoS profile information, and the security profile information.

15. The integrative network management apparatus of claim 14, wherein the control server notifies the entity of the tunnel control information to TCSs on the network and receives a response thereto to reflect the response to the state value of the tunnel control information.

16. The integrative network management apparatus of claim 15, wherein the control server adds the hidden IP address of the user equipment, the hidden IP address of the security gateway at the service server side, and the DSCP value included in the service profile information to an entity of connection profile information among the profile management information so as to include the hidden IP address of the user equipment, the hidden IP address of the security gateway at the service server side, and the DSCP value included in the service profile information and
adds an entity of tunnel usage information among the setting management information so as to include the added entity of the tunnel control information and the added entity of the connection profile information.
